(19) United States
(12) Patent Application Publication
(10) Pub. No.: US 2010/0144369 A1
(43) Pub. Date: Jun. 10, 2010

(54) CUSTOMER PREMISES EQUIPMENT AND METHOD FOR SENDING LOCATION INFORMATION OF THE CUSTOMER PREMISES EQUIPMENT

(75) Inventors: CHUNG-HO WU, Tu-Cheng (TW); CHI-HSIEN HUANG, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/406,037

(22) Filed: Mar. 17, 2009

(30) Foreign Application Priority Data
Dec. 9, 2008 (CN) 200810306063.4

(51) Int. Cl. H04W 24/00

(52) U.S. Cl. 455/456.2

(57) ABSTRACT

A customer premises equipment (CPE) for sending location information of the customer premises equipment over the Internet includes a request module, a positioning module, and an address sending module. The request module is configured for determining if a physical location of the CPE needs to be sent based at least partly on a setting or a command from a user, and sending a request message to request the physical location of the CPE. The positioning module is configured for searching positioning coordinates of the CPE according to the request message, and transforming the positioning coordinates to the physical location of the CPE. The address sending module is configured for sending the physical location of the CPE over the Internet.

### BACKGROUND

1. Technical Field

Embodiments of the present disclosure relate to network devices, and particularly to a customer premises equipment (CPE) and a method for sending location information of the CPE.

2. Description of Related Art

Presently, a customer premises equipment (CPE), such as a cable modem, is often used for providing Internet accessing service to users, and for searching a physical location of the CPE using an Internet protocol (IP) address assigned by an Internet service provider (ISP).

However, the aforementioned method takes a long time to search the physical location of the CPE, and may be inaccurate. Therefore, the CPE cannot exactly send the physical location of the CPE according to a user's requirements.

### BRIEF DESCRIPTION OF THE DRAWINGS

FIG. 1 is a schematic diagram of an application environment and functional modules of one embodiment of a customer premises equipment (CPE) in accordance with the present disclosure; and

FIG. 2 is a flowchart of one embodiment of a method for sending location information of the CPE in accordance with the present disclosure.

### DETAILED DESCRIPTION OF CERTAIN INVENTIVE EMBODIMENTS

All of the processes described may be embodied in, and fully automated via, software code modules executed by one or more general purpose computers or processors. The code modules may be stored in any type of computer-readable medium or other storage device. Some or all of the methods may alternatively be embodied in specialized computer hardware or communication apparatus.

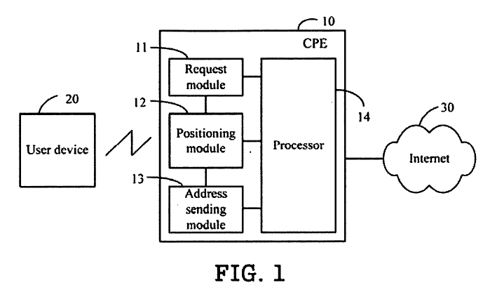

FIG. 1 is a schematic diagram of an application environment and functional modules of one embodiment of a customer premises equipment (CPE) 10 in accordance with the present disclosure. In one embodiment, the CPE 10 is connected between the Internet 30 and a user device 20, for providing Internet accessing service to the user device 20. The CPE 10 may be a cable modem, a digital subscriber line (DSL) modem, an access point, etc. The user device 20 may be a personal computer (PC), a voice over Internet protocol (VoIP) phone, a notebook computer, etc.

The CPE 10 can send a physical location of the CPE 10 over the Internet 30. For example, the CPE 10 adds the physical location of the CPE 10 to a voice packet and sends the voice packet with the physical location over the Internet 30, when a user of the user device 20 dials emergency calls such as 911 via the CPE 10. The physical location of the CPE 10 may be sent to a police station over the Internet 30, in one example. Then, a policeman will know that a physical location of the user is same as or very close to the physical location of the CPE 10 in substantially real-time, and help the user as soon as possible.

In one embodiment, the CPE 10 includes a request module 11, a positioning module 12, an address sending module 13, and a processor 14. The processor 14 is configured for executing one or more operations for the request module 11, the positioning module 12, and the address sending module 13.

The request module 11 is configured for sending a request message to the positioning module 12 to request a physical location of the CPE 10. In one embodiment, the request module 11 determines if the physical location of the CPE 10 needs to be sent, and then sends the request message to the positioning module 12 upon the condition that the physical location needs to be sent. The determination may be based at least partly on a setting or a command from a user.

The positioning module 12 is configured for searching positioning coordinates of the CPE 10 according to the request message, and transforming the positioning coordinates to the physical location of the CPE 10. In one embodiment, the positioning module 12 may be a global positioning system (GPS) module, which searches the positioning coordinates of the CPE 10 from a GPS satellite. The positioning coordinates of the CPE 10 includes longitude and latitude information of the CPE 10. The GPS module may be an antenna in one example.

The address sending module 13 is configured for sending the physical location of the CPE 10 over the Internet 30. In one embodiment, the address sending module 13 adds the physical location of the CPE 10 to a data packet, and then transmits the data packet with the physical location over the Internet 30. The data packet, as mentioned above, may be a voice packet containing voice data from one user to another user.

In other embodiments, the positioning module 12 may not need to transform the positioning coordinates to the physical location of the CPE 10, and accordingly the address sending module 13 directly adds the positioning coordinates of the CPE 10 to a data packet, and sends the data packet with the positioning coordinates over the Internet 30. In such a case, a receiver will receive the positioning coordinates of the CPE 10 over the Internet 30, and transform the positioning coordinates to the physical location of the CPE 10.

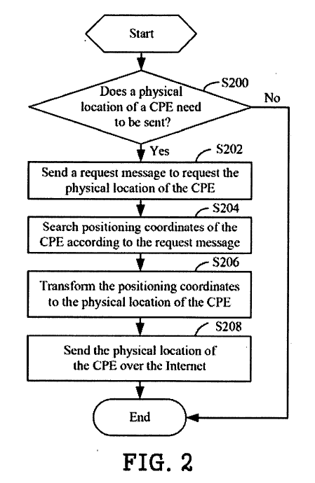

FIG. 2 is a flowchart of one embodiment of a method for sending location information of the CPE 10 in accordance with the present disclosure. In one embodiment, the method is executed by the functional modules of FIG. 1. Depending on the embodiment, additional blocks may be added, others may be deleted, and the ordering of the blocks may be changed.

In block S200, the request module 11 determines if a physical location of the CPE 10 needs to be sent. In one embodiment, the request module 11 determines if the physical location of the CPE 10 needs to be sent according to at least partly based on a setting or a command from a user. In one example, the request module 11 determines that the physical location of the CPE 10 needs to be sent, such as when a user of the user device 20 dials an emergency call via the CPE 10.

If the physical location needs to be sent, the request module 11 sends a request message to the positioning module 12 to request the physical location of the CPE 10 as described in block S202.

In block S204, the positioning module 12 searches positioning coordinates of the CPE 10 according to the request message. In one embodiment, the positioning module 12 is a GPS module, which searches the positioning coordinates of the CPE 10 from a GPS satellite. The positioning coordinates of the CPE 10 includes longitude and latitude information of the CPE 10.

In block S206, the positioning module 12 transforms the positioning coordinates of the CPE to the physical location of the CPE 10.

In block S208, the address sending module 13 sends the physical location of the CPE 10 over the Internet 30. In one embodiment, the address sending module 13 adds the physical location of the CPE 10 to a data packet, and then transmits the data packet with the physical location over the Internet 30.

In other embodiments, block S206 may be omitted, that is, the positioning module 12 may not need to transform the positioning coordinates of the CPE 10 to the physical location of the CPE 10. Accordingly, the address sending module 13 directly adds the positioning coordinates of the CPE 10 to a data packet, and sends the data packet with the positioning coordinates over the Internet 30.

Thus, the CPE 10 searches the physical location of the CPE 10 via the positioning module 12, and accordingly sends the physical location of the CPE 10 over the Internet 30. The CPE 10, via the positioning module 12, may pinpoint the location of the CPE 10 in substantially real-time.

While various embodiments and methods of the present disclosure have been described above, it should be understood that they have been presented by way of example only and not by way of limitation. Thus the breadth and scope of the present disclosure should not be limited by the above-described embodiments, but should be defined only in accordance with the following claims and their equivalents.

What is claimed is:

1. A customer premises equipment adapted for sending location information of the customer premises equipment over the Internet, the customer premises equipment comprising:
a request module configured for determining if a physical location of the customer premises equipment needs to be sent, and sending a request message to request the physical location, wherein the determination is based at least partly on a setting or a command from a user;
a positioning module configured for searching positioning coordinates of the customer premises equipment according to the request message, and transforming the positioning coordinates to the physical location of the customer premises equipment; and
an address sending module configured for sending the physical location of the customer premises equipment over the Internet.

2. The customer premises equipment of claim 1, wherein the positioning module is a global positioning system module.

3. The customer premises equipment of claim 2, wherein the positioning coordinates of the customer premises equipment comprises longitude and latitude information of the customer premises equipment.

4. The customer premises equipment of claim 1, wherein the address sending module is further configured for adding the physical location of the customer premises equipment to a data packet, and sending the data packet with the physical location over the Internet.

5. The customer premises equipment of claim 1, wherein the address sending module is further configured for adding the positioning coordinates of the customer premises equipment to a data packet, and sending the data packet with the positioning coordinates over the Internet.

6. The customer premises equipment of claim 1, wherein the customer premises equipment is selected from the group consisting of a cable modem, a digital subscriber line modem, and an access point.

7. A method for sending location information of a customer premises equipment over the Internet, the method comprising:
determining if a physical location of the customer premises equipment needs to be sent, wherein the determination is based at least partly on a setting or a command from a user;
in response to the physical location needs to be sent, sending a request message to a positioning module to request the physical location;
searching positioning coordinates of the customer premises equipment according to the request message using the positioning module;
transforming the positioning coordinates to the physical location of the customer premises equipment using the positioning module; and
sending the physical location of the customer premises equipment over the Internet.

8. The method of claim 7, wherein the positioning module is a global positioning system module.

9. The method of claim 8, wherein the positioning coordinates of the customer premises equipment comprises longitude and latitude information of the customer premises equipment.

10. The method of claim 7, wherein the sending step comprises:
adding the physical location of the customer premises equipment to a data packet; and
sending the data packet with the physical location over the Internet.

11. The method of claim 7, further comprising:
adding the positioning coordinates of the customer premises equipment to a data packet; and
sending the data packet with the positioning coordinates over the Internet.

12. The method of claim 7, wherein the customer premises equipment is selected from the group consisting of a cable modem, a digital subscriber line modem, and an access point.
